(19) United States
(12) Patent Application Publication
(10) Pub. No.: US 2015/0215840 A1
(43) Pub. Date: Jul. 30, 2015

(54) SYSTEMS, METHODS AND DEVICES FOR APPLICATION SPECIFIC ROUTING IN DUAL CONNECTIVITY

(71) Applicant: Intel IP Corporation, Santa Clara, CA (US)

(72) Inventors: CANDY YIU, Beaverton, OR (US); ANA LUCIA A. PINHEIRO, Breinigsville, PA (US)

(73) Assignee: Intel IP Corporation, Santa Clara, CA (US)

(21) Appl. No.: 14/580,797

(22) Filed: Dec. 23, 2014

Related U.S. Application Data
(60) Provisional application No. 61/933,865, filed on Jan. 30, 2014.

(51) Int. Cl. H04W 40/02; H04W 80/08; H04W 84/12; H04W 88/06

(52) U.S. Cl. CPC H04W 40/02; H04W 88/06; H04W 80/08; H04W 84/12

(57) ABSTRACT

A wireless service provider can route packets in a dual connectivity wireless system based on application (instead of solely on bearers). For example, an evolved Node B can split a bearer between a master eNB (MeNB) and a secondary wireless connection (such as a secondary eNB (SeNB)). User equipment (UE) can connect to a both a MeNB and a SeNB and split a bearer based on application type. Instead of basing data forwarding on a bearer, packet routing can be based on other attributes (such as IP address, application, application type, etc.). This dual connectivity allows MeNB to schedule data forwarding based on application. Data packets assigned to a bearer can be divided among the MeNB and SeNB based on desirable attributes of the MeNB and SeNB for an application.

### RELATED APPLICATION

This application claims the benefit under 35 U.S.C. §119(e) of U.S. Provisional Application No. 61/933,865 filed Jan. 30, 2014, which is incorporated by reference herein in its entirety.

### TECHNICAL FIELD

The present disclosure relates to dual connectivity in wireless devices.

### BRIEF DESCRIPTION OF THE DRAWINGS

FIG. 1 is a diagram illustrating a wireless dual connectivity system consistent with embodiments disclosed herein.

FIG. 2 is a diagram illustrating a protocol stack in single connectivity consistent with embodiments disclosed herein.

FIG. 3 is a diagram of a protocol stack in dual connectivity consistent with embodiments disclosed herein.

FIG. 4 is a diagram of an alternate protocol stack in dual connectivity consistent with embodiments disclosed herein.

FIG. 5 is diagram illustrating filtering based on application consistent with embodiments disclosed herein.

FIG. 6 is a diagram illustrating multiple traffic flow template (TFT) assignment consistent with embodiments disclosed herein.

FIG. 7 is a diagram illustrating a wireless communication system consistent with embodiments disclosed herein.

FIG. 8 is a data flow diagram illustrating data flow of an evolved packet core (EPC) in a dual connectivity environment consistent with embodiments disclosed herein.

FIG. 9 is a data flow diagram illustrating data flow between a UE and Serving Gateway/Packet Data Network (PDN) Gateway (S/P-GW) in dual connectivity consistent with embodiments disclosed herein.

FIG. 10 is a flow chart illustrating a method for application specific routing consistent with embodiments disclosed herein.

FIG. 11 is a schematic diagram of a mobile device consistent with embodiments disclosed herein.

### DETAILED DESCRIPTION OF PREFERRED EMBODIMENTS

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Techniques, apparatus and methods are disclosed that enable a wireless service provider to route packets in a dual connectivity wireless system based on application (instead of solely on bearers). For example, an evolved Node B (also commonly denoted as Node B, enhanced Node B, eNodeB, or eNB) can split a bearer between a master eNB (MeNB) and a secondary wireless connection (such as a secondary eNB (SeNB)). User equipment (UE) can connect to both a MeNB and a SeNB and split a bearer based on application type. Instead of basing data forwarding on a bearer, packet routing can be based on other attributes (such as IP address, application, application type, etc.). This dual connectivity allows MeNB to schedule data forwarding based on application. Data packets assigned to a bearer can be divided among the MeNB and SeNB based on desirable attributes of the MeNB and SeNB for an application (such as reliability or speed).

Traditionally, a UE is connected to one eNB. In dual connectivity the UE can connect to more than one eNB (referred to here as MeNB and SeNB) simultaneously to increase a UE data rate and offload transmissions to Macro cells. For example, the MeNB determines to add a SeNB and selected bearers are serviced through the MeNB and others through the SeNB.

In some embodiments, it can be beneficial to perform bearer separations based on applications. Without additional information, an eNB does not have knowledge of an application type such as voice, video or SMS. Instead, each bearer is associated with a quality of service class identifier (QCI) for quality of service (QoS). However, QCI levels are not currently application specific and for QCI levels from QCI=5 onwards many different application groups are mapped into the same QCI level. In a dual connectivity case, the eNB has very limited ability today to forward data based on the applications mapped to the bearers.

Five example embodiments are described below that can be used for application specific routing (although these embodiments are not meant to be exhaustive and combinations thereof can be created): (1) a QCI table can be extended; (2) an application table can be created; (3) TFTs can be extended; (4) multiple TFTs can be used for a single bearer and (5) other networks can be used.

A packet splitter (such as a packet filter, packet router, packet inspector, etc.) can be added before, in or after a packet data convergence protocol (PDCP) layer. In some embodiments, a filter is added before a PDCP layer (such as on top of the PDCP layer or in a gateway such as a serving gateway (S-GW, SGW)) or a serving gateway/packet data network (PND) gateway (SPGW or S/P-GW). In other embodiments, a filter resides in (or with) the PDCP layer. As packets arrive to the packet filter, the packets can routed through a wireless link based on their association with an application (or part of an application). For example, a packet filter can be configured to route a voice portion of a video chat application through a MeNB, while a video portion can be configured to be routed through a SeNB.

In an embodiment, one given bearer can be split between the MeNB and SeNB. A packet filter can split a stream of packets from one bearer to MeNB and SeNB based on characteristics (IP address, extended QCI level, application table, etc.).

In some embodiments, the filtering is based on an application table. An application table can contain a list of applications matched with IP addresses. This table can then be used by a packet filter to determine which wireless link, connection, eNB, medium or set of frequencies should be used to transmit a packet.

It should be recognized that transmission over a wireless link can be expressed in different ways. In many instances, transmission can be over a wireless link, connection, eNB, medium or set of frequencies. While specific embodiments may be described using one set of terminology, it should be recognized that other terminology can be applicable. A wireless medium is a link between two wireless systems that can transmit information. More than one wireless mediums (or media) can exist, as each medium is associated with a link (such as different wireless frequencies, different link technologies, etc.)

In other embodiments, the filtering can be based on an extended QCI table. A QCI table can be extended to include applications. Each application type can be assigned a QCI value. A packet filter can examine a QCI value of the packet within a stream and make a determination of the routing of the packet over a primary wireless link or secondary wireless link.

In an embodiment, current traffic flow templates (TFTs) can be extended to allow multiple TFTs to be mapped to a single bearer. A network can set two or more TFTs to map to a single bearer. Packets in the split bearer can map into one of the two TFTs.

In some embodiments, the packet filter is not limited to long term evolution (LTE) networks, but can be applied to other links, such as a wireless local area network (WLAN) link. For example, an eNB can configure associated TFTs and packet filters on the LTE bearer and a WLAN link.

In other embodiments, multiple TFTs can be configured for a single bearer. For example, a bearer can be established with a first TFT. A second TFT can be created such that packets that are within the first TFT and also match a second TFT can be routed according to the second TFT.

This data routing can use wireless mobile communication technology between a UE and one or more base stations. Wireless mobile communication technology uses various standards and protocols to transmit data between a base station and a wireless mobile device. Wireless communication system standards and protocols can include the 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard, which is commonly known to industry groups as Wi-Fi. Mobile broadband networks can include various high speed data technologies, such as 3GPP LTE systems. In 3GPP radio access networks (RANs) in LTE systems, the base station can include Evolved Universal Terrestrial Radio Access Network (E-UTRAN) Node Bs (also commonly denoted as evolved Node Bs, enhanced Node Bs, eNodeBs, or eNBs) and/or Radio Network Controllers (RNCs) in an E-UTRAN, which communicate with a wireless communication device, known as user equipment (UE). The eNBs allow the UE to connect to further network infrastructure, such as an evolved packet core (EPC), which can include gateways (such as an S-GW) and applications and/or services (including Internet access).

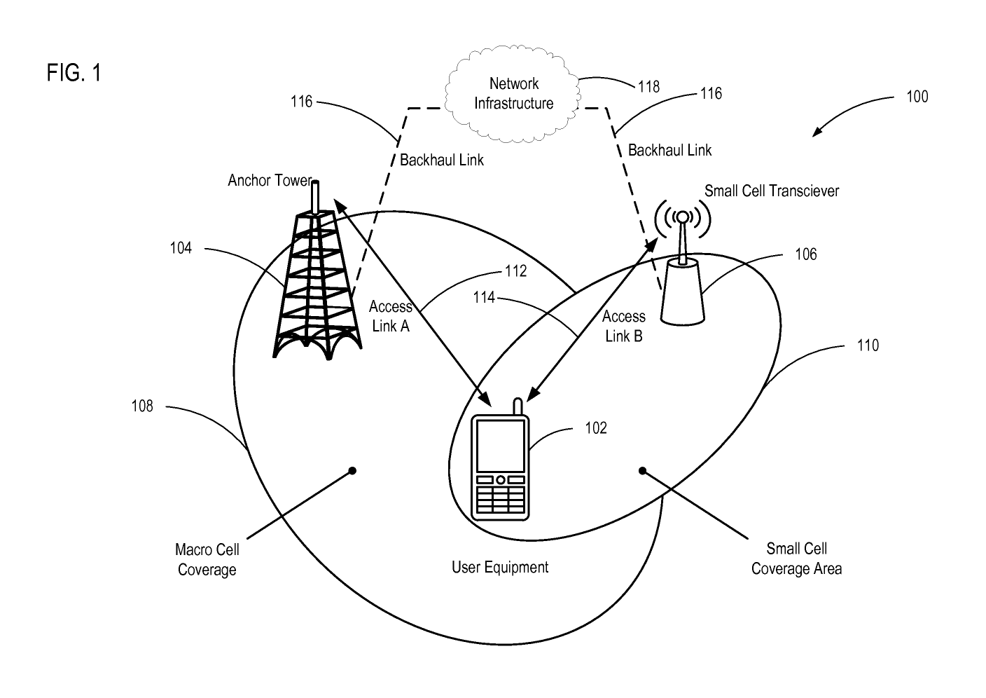

FIG. 1 shows an example of a portion of a radio access network (RAN) system 100 that includes a single cellular air interface (such as an LTE/LTE-Advanced access link) being provided between the anchor tower 104 (such as an eNB) and the UE 102 (i.e., on Access Link A 112), and an air interface (a supplemental network interface such as a small cell based interface or wireless local area network (WLAN) based interface) being provided between the small cell transceiver 106 and the UE 102 (i.e., on Access Link B 114). UE 102 is located within macro cell coverage 108 and small cell coverage area 110. Anchor tower 104 determines that connection with a small cell transceiver 106 will be beneficial to a user of the UE 102. The UE 102 can retain Access Link A 112 to anchor tower 104. The anchor tower 104 and UE 102 can offload some or part of wireless services onto Access Link B 114. In some embodiments Access Link A 112 and Access Link B 114 use a same frequency and technology. In other embodiments, Access Link A 112 and Access Link B 114 use different frequencies (e.g., LTE licensed frequencies and unlicensed frequencies) and different link technology (e.g., LTE and WLAN). In other embodiments, Access Link A 112 and Access Link B 114 use different frequencies and similar link technology (e.g., LTE and LTE over mmWave).

Data can be routed over Access Link A 112 or Access Link B based on a packet filter determination. In one embodiment, a gateway in the network infrastructure 118 can transmit packets over a backhaul link 116 to a MeNB (such as anchor tower 104). The MeNB can determine that the UE 102 should connect to a SeNB (such as small cell transceiver 106). The MeNB can instruct the UE 102 to connect to the SeNB. As a result a packet filter can be enabled on the MeNB and SeNB. Packets can be routed through the MeNB or SeNB based on application. A packet can be received by the MeNB and then routed to the SeNB. Alternatively, a packet filter can operate above the level of the eNB and routed to the MeNB or SeNB based on an identifier that correlates with an application.

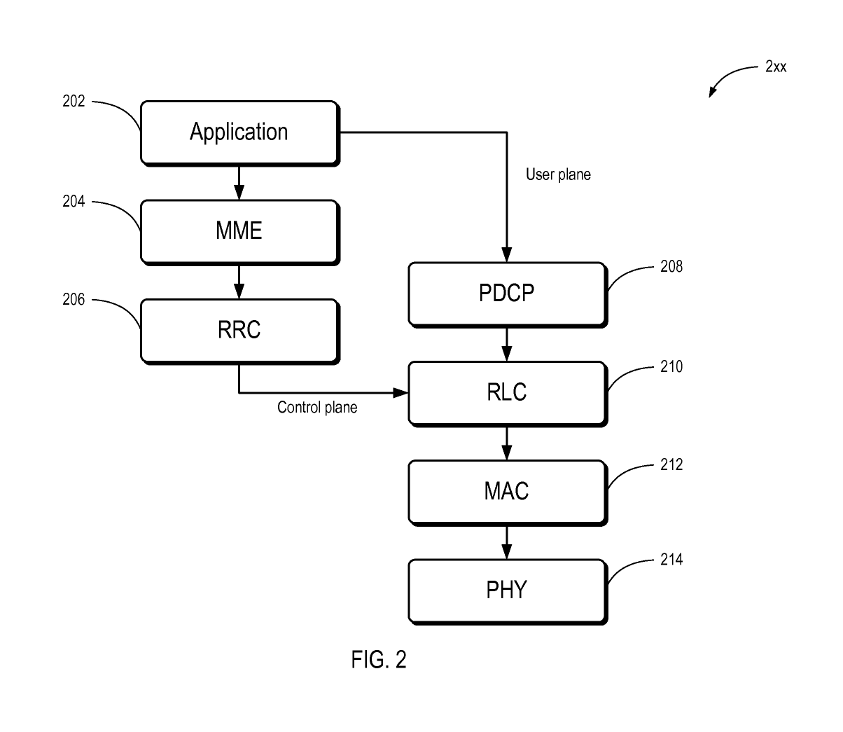

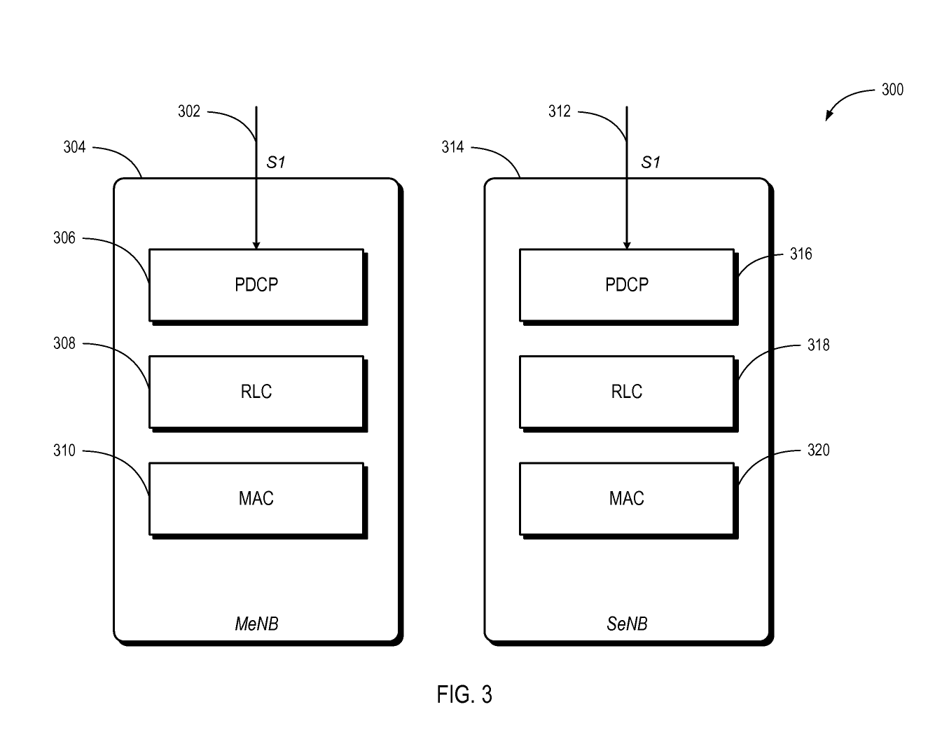

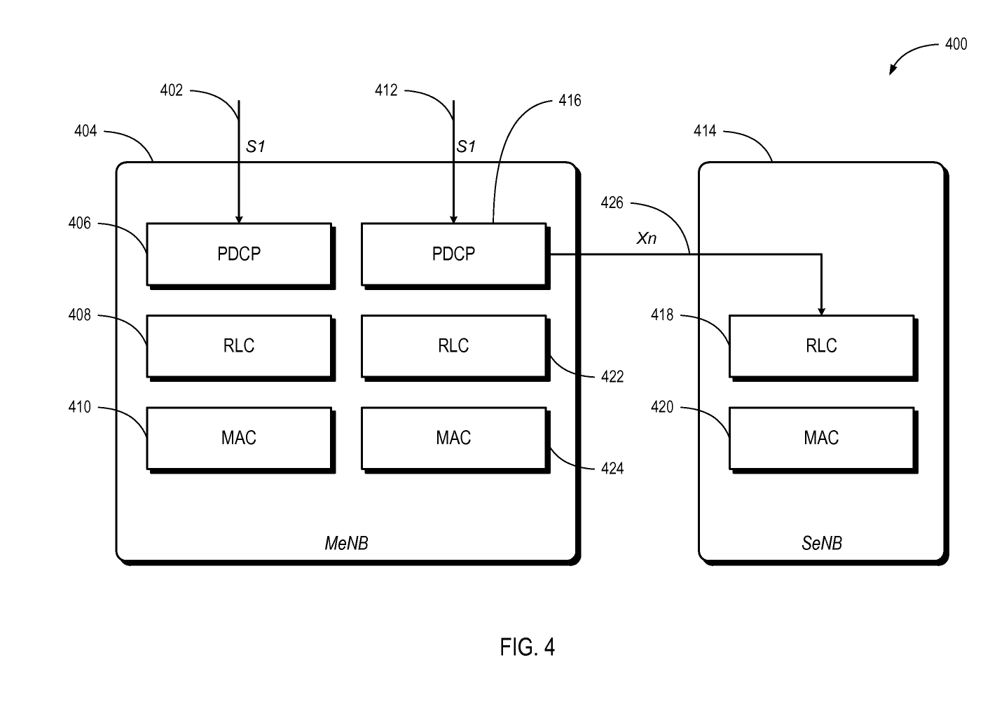

FIGS. 2-4 show various protocol stacks that a wireless system (such as an EPC or UE) can use to communicate over a wireless medium. FIG. 2 shows a single connectivity embodiment. FIG. 3 shows an embodiment in what is known as option 1A in a dual connectivity environment and includes packet routing before the PDCP layer. FIG. 4 shows an embodiment in what is known as option 3C in a dual connectivity environment and includes packet routing in the PDCP layer, which can also allow a bearer split.

FIG. 2 shows a protocol architecture in single connectivity embodiment. When a UE (such as a UE 102 from FIG. 1) requests for establishment of a bearer, the network will set up a bearer based on QCI and data will be sent via a different bearer based on the QCI. Packets received from the application layer 202 on a user plane are provided to the PDCP layer 208.

The PDCP layer can add a PDCP header, perform IP header compression, transfer user data and maintain sequence numbers for radio bearers. After it operates on packets, the PDCP layer 208 provides the packet to a radio link control (RLC) layer 210.

The RLC layer 210 includes functionality to provide an automatic repeat request (ARQ) fragmentation protocol; transfer of upper layer protocol data units (PDUs); concatenation, segmentation and reassembly of RLC service data units (SDUs); re-segmentation of RLC data PDUs, and in-sequence delivery of upper layer PDUs; duplicate detection, protocol error detection and recovery; and RLC SDU discard and/or RLC re-establishment. After the RLC layer 210 operates on packets, the RLC layer 210 provides the packets to a medium access control (MAC) layer 212.

The MAC layer 212 can provide mapping between logical channels and transport channels, multiplexing/demultiplexing of MAC SDUs belonging to logical channels into/from transport blocks to/from the physical (PHY) layer 214 on transport channels, error correction through hybrid automatic repeat request (HARM), priority handling between logical channels, and priority handling between UEs by dynamic scheduling and/or transport format selection. After the MAC layer 212 operates on packets, the MAC layer 212 provides the packets to the PHY layer 214. Thy PHY layer 214 translates the packets received from the MAC layer 212 into electrical signals to transmit over a wireless medium.

Packets can also be routed through a control plane. Control information can be passed from the application layer 202 to a mobility management entity (MME) layer 204. The MME layer 204 can provide services such as bearer activation/deactivation, paging, tagging and user authentication. Control information can then be passed from the MME layer 204 to a radio resource layer (RRC) 206. RRC layer 206 can provide functions that include broadcasting system information related to non-access stratum (NAS) or access stratum (AS), paging, configuring RRC connections between UE and E-UTRAN, security functions, configuring of radio bearers, mobility functions, QoS management and UE measurement reporting.

Turning to embodiments with dual connectivity, architecture option 1A is shown in FIG. 3 without a bearer split and option 3C is shown in FIG. 4 with a bearer split. In both architectures a UE is connected to a MeNB 404 and a SeNB 414. Without further configuration, there is no filtering based on application to send the data to the UE via MeNB 404 and SeNB 414. An application based filter can be added to split incoming data 412 into two data flows (one flow goes to MeNB and one flow goes to SeNB). This filter can reside in PDCP layer 416 in option 3C shown in FIG. 4 or before PDCP layers 306 and 316 (e.g., on top of a PDCP layer) in option 1A shown in FIG. 3, or even in the S-GW (not shown). This filter can be configured (such as by the MeNB 404 or the MME). The filter can be pre-configured (such as selecting a pre-made filter based on known or predicted application demands) or configured upon enablement (such as by receiving configuration information by current applications).

FIG. 4 shows an embodiment of a protocol stack that receives data 402 and 412 from two bearers, one of which is split (the bearer containing data 412). Data 402 travels a path through PDCP layer 406 to RLC layer 408 to MAC layer 410 and out through a PHY layer of the MeNB 404. Data 412, however, is filtered at the PDCP layer 416 by a packet filter. Some data passes through the MeNB 404 through PDCP layer 416, RLC layer 422, MAC layer 424 and out through a PHY layer of the MeNB 404. Part of data 412 is split from MeNB to SeNB at PDCP layer 416 and sent over link Xn 426 to SeNB 414. The SeNB 414 then passes the data through RLC layer 418, MAC layer 420 and out through a PHY layer of the SeNB 414.

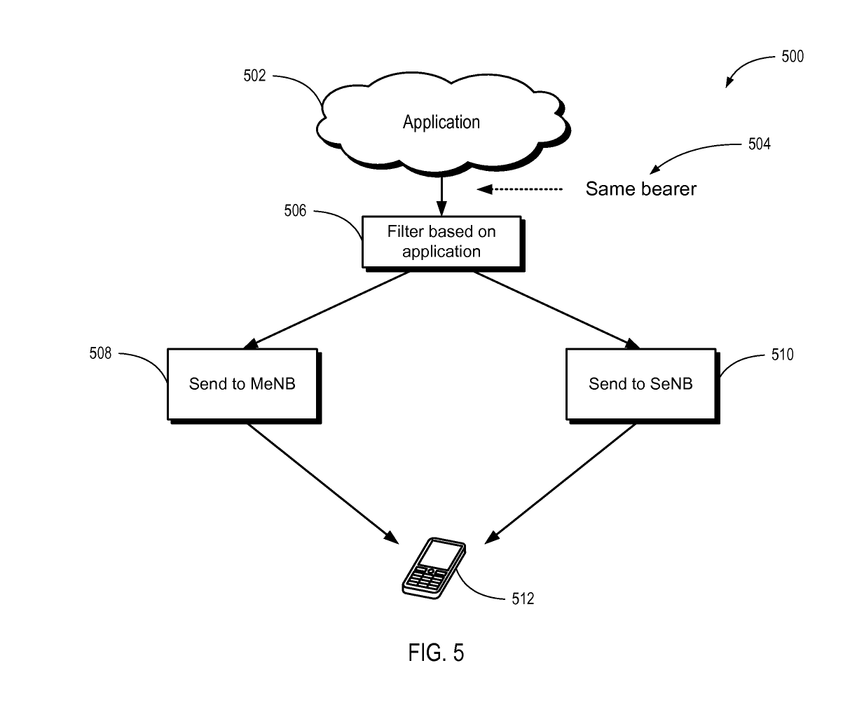

In FIG. 5, an example of a filter 506 is shown splitting a same bearer 504 into two flows based on the application in system 500. Such application data flow is sent to a UE 512 via different eNBs 508 and 510 through dual connectivity. The routing of the flow can be based on a load and a coverage of each eNB 508 and 510. For instance, a MeNB 508 is selected to have more reliable and larger coverage than a selected SeNB 510. However, the MeNB 508 can be more overloaded than SeNB 510. Therefore application traffic requiring a higher reliability (such as an increase in coverage area, a decreased chance of losing connection, decreased latency, etc.) can be sent over the MeNB 508 (such as voice traffic), while traffic requiring a higher throughput can be sent over the SeNB 510 (such as video data).

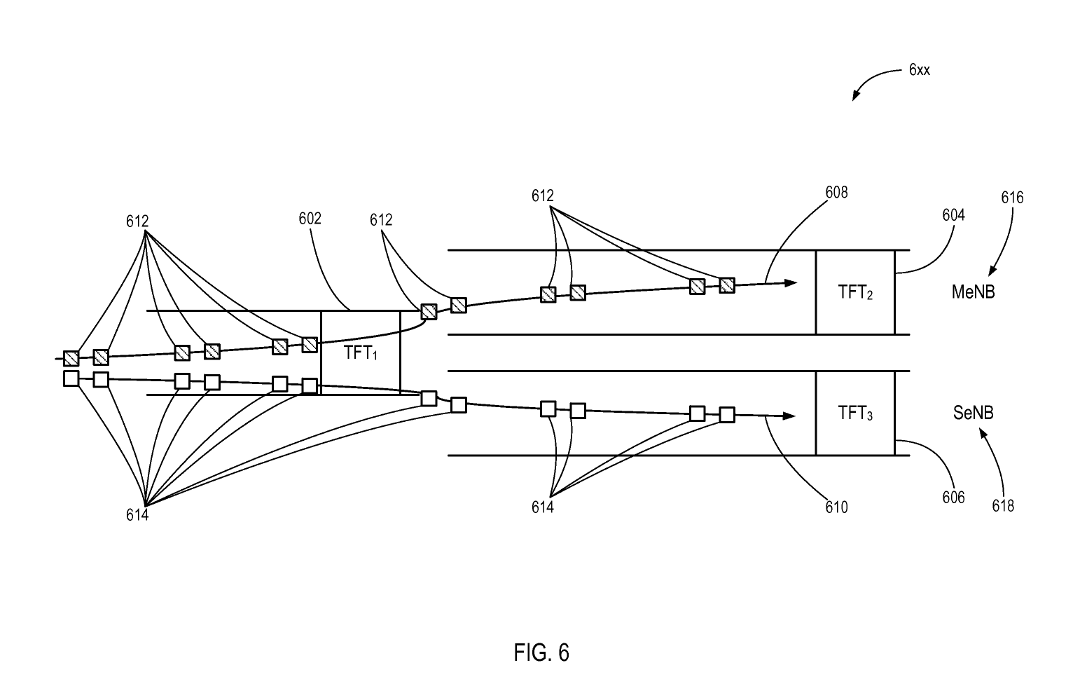

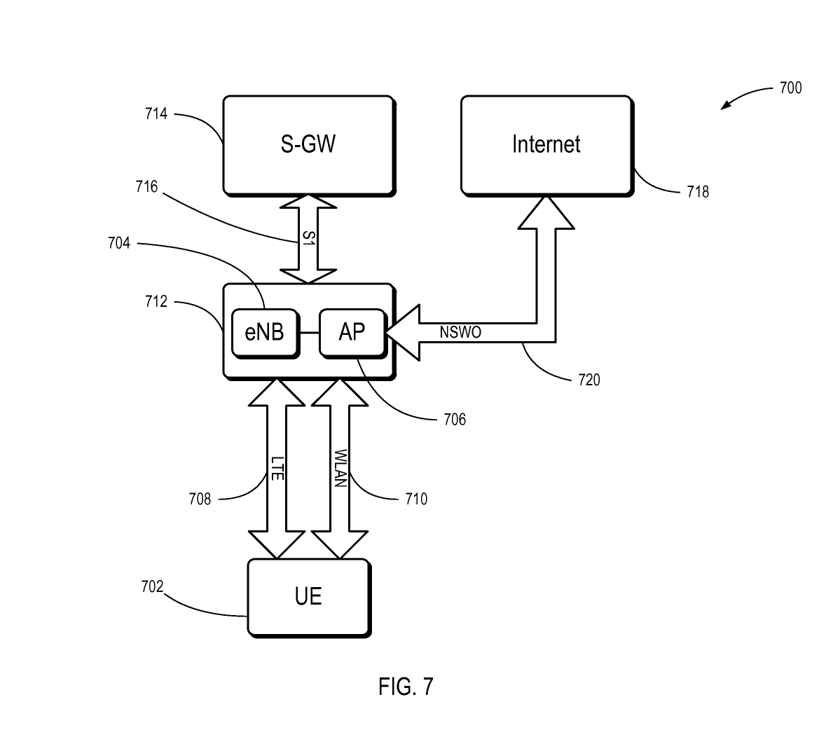

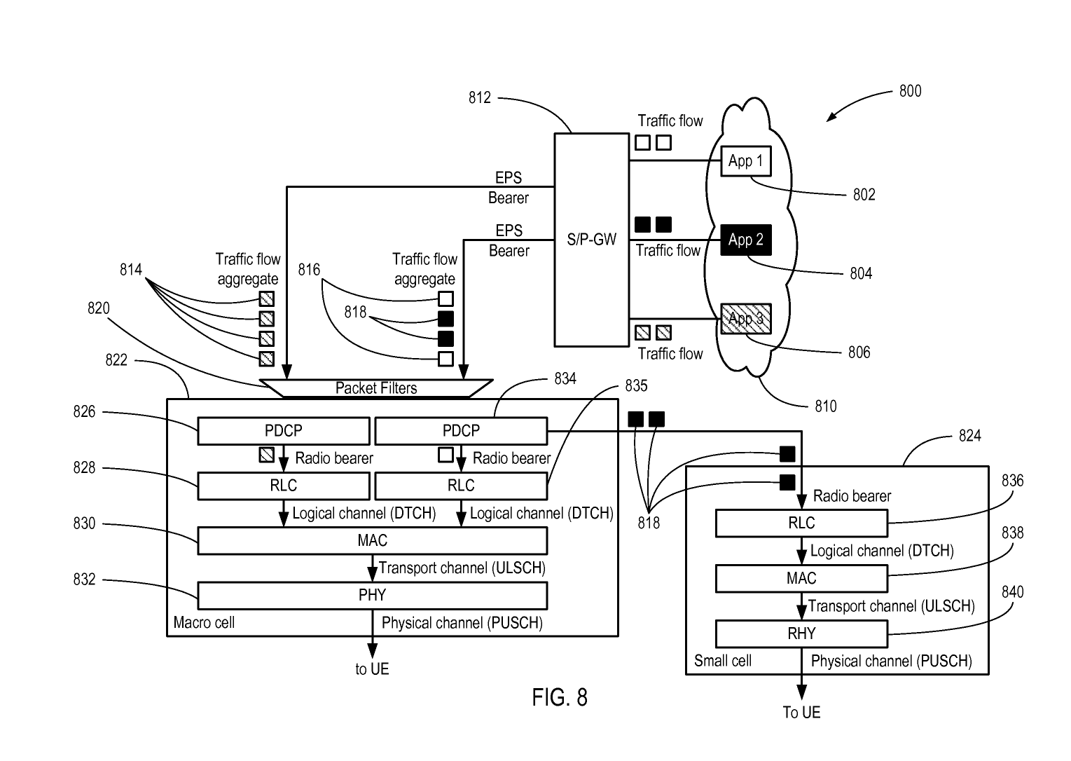

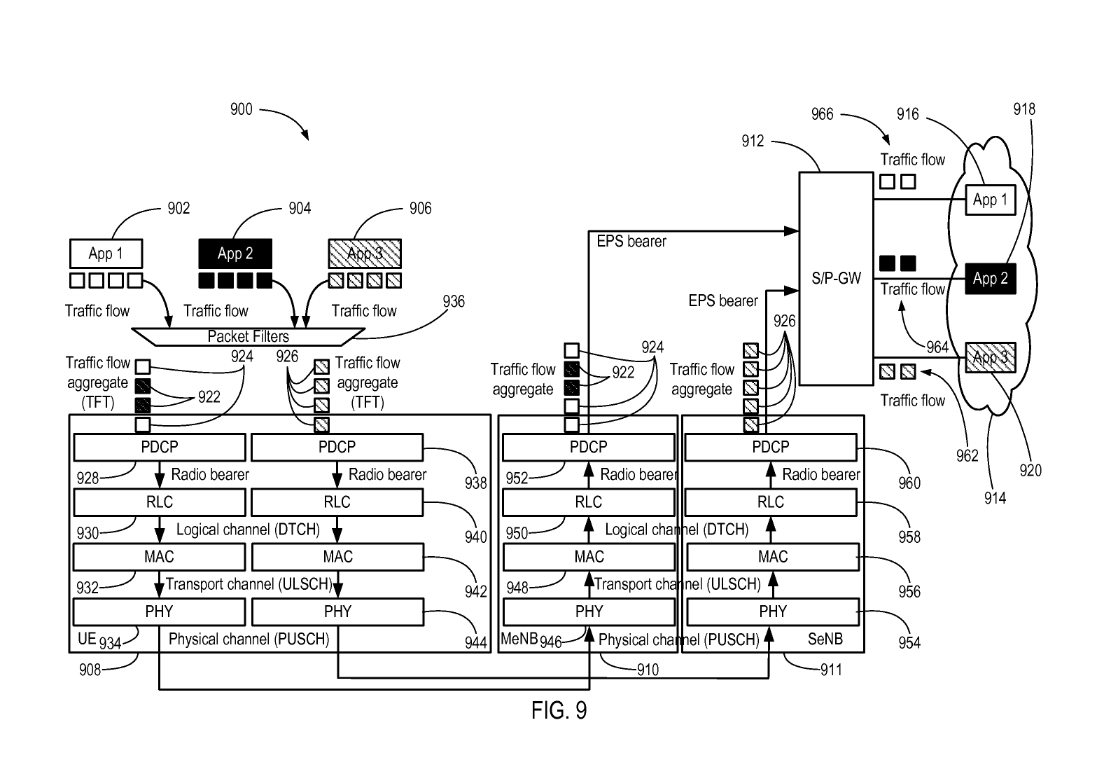

FIGS. 6 through 9 show example embodiments that use application dependent filtering in dual connectivity for application specific routing. FIGS. 6 and 7 show examples of high-level views of systems using application specific routing, while FIGS. 8 and 9 show more detailed embodiments of routing. Five example embodiments are described below that can be used for application specific routing (although these embodiments are not meant to be exhaustive and combinations thereof can be created): (1) a QCI table can be extended; (2) an application table can be created; (3) TFTs can be extended; (4) multiple TFTs can be used for a single bearer and (5) other networks can be used. While the embodiments described herein may focus on enhancements to a MeNB, it should be recognized that these enhancements can also be applied in a P-GW (including embodiments of dual connectivity as shown in FIG. 3).

The Figures will be examined in the order of FIG. 6, FIGS. 8-9 and then FIG. 7, as aspects based on FIG. 7 can be also applied to FIGS. 8 and 9. For example, extended TFTs or multiple TFTs can be used in conjunction with WLAN technologies in a dual connectivity system.

In an embodiment (1), an existing QCI table (such as Table 1) can be extended such that each application type is added into a QCI value. When using a QCI table based embodiment for application dependent filtering, more bearers will be set up. In an embodiment with a bearer split in dual connectivity, a MeNB will select a bearer and offload the bearer to a SeNB. For example, Table 1 describes nine QCI classes. Additional classes can be defined for application types, such as latency tolerant game caching (e.g., background downloading of large amounts of game content) and real-time gaming updates (e.g., small amounts of real-time position and action information). Using extended QCI with packet filters can allow application specific filtering.

TABLE 1
Example QCI Table and Characteristics

| | | | Packet Delay | Packet Error | |
|---|---|---|---|---|---|
| | Resource | | Budget | Loss Rate | |
| QCI | Type | Priority | (NOTE 1) | (NOTE 2) | Example Services |
| 1 | GBR | 2 | 100 ms | 10⁻² | Conversational Voice |
| (NOTE 3) | | | | | |
| 2 | | 4 | 150 ms | 10⁻³ | Conversational Video |
| (NOTE 3) | | | | | (Live Streaming) |
| 3 | | 3 | 50 ms | 10⁻³ | Real Time Gaming |
| (NOTE 3) | | | | | |
| 4 | | 5 | 300 ms | 10⁻⁶ | Non-Conversational Video |
| (NOTE 3) | | | | | (Buffered Streaming) |
| 5 | Non- | 1 | 100 ms | 10⁻⁶ | IMS Signalling |
| (NOTE 3) | GBR | | | | |
| 6 | | 6 | 300 ms | 10⁻⁶ | Video (Buffered Streaming) |
| (NOTE 4) | | | | | TCP-Based (e.g., www, e-mail, |
| | | | | | chat, ftp, p2p file sharing, |
| | | | | | progressive video, etc.) |
| 7 | | 7 | 100 ms | 10⁻³ | Voice, |
| (NOTE 3) | | | | | Video (Live Streaming) |
| | | | | | Interactive Gaming |
| 8 | | 8 | 300 ms | 10⁻⁶ | Video (Buffered Streaming) |
| (NOTE 5) | | | | | TCP-Based (e.g., www, e-mail, |
| | | | | | chat, ftp, p2p file sharing, |
| | | | | | progressive video, etc.) |
| 9 | | 9 | | | |
| (NOTE 6) | | | | | |

NOTE 1:
A delay of 20 ms for the delay between a PCEF and a radio base station should be subtracted from a given PDB to derive the packet delay budget that applies to the radio interface. This delay is the average between the case where the PCEF is located “close” to the radio base station (roughly 10 ms) and the case where the PCEF is located “far” from the radio base station, e.g., in case of roaming with home routed traffic (the one-way packet delay between Europe and the U.S. west coast is roughly 50 ms). The average takes into account that roaming is a less typical scenario. It is expected that subtracting this average delay of 20 ms from a given PDB will lead to desired end-to-end performance in most typical cases. Also, note that the PDB defines an upper bound. Actual packet delays - in particular for GBR traffic - should typically be lower than the PDB specified for a QCI as long as the UE has sufficient radio channel quality.
NOTE 2:
The rate of non-congestion related packet losses that may occur between a radio base station and a PCEF should be regarded to be negligible. A PELR value specified for a standardized QCI therefore applies completely to the radio interface between a UE and radio base station.
NOTE 3:
This QCI is typically associated with an operator controlled service, i.e., a service where the SDF aggregate's uplink/downlink packet filters are known at the point in time when the SDF aggregate is authorized. In case of E-UTRAN this is the point in time when a corresponding dedicated EPS bearer is established/modified.
NOTE 4:
If the network supports Multimedia Priority Services (MPS) then this QCI could be used for the prioritization of non-real-time data (i.e., most typically TCP-based services/applications) of MPS subscribers.
NOTE 5:
This QCI could be used for a dedicated “premium bearer” (e.g., associated with premium content) for any subscriber/subscriber group. Also in this case, the SDF aggregate's uplink/downlink packet filters are known at the point in time when the SDF aggregate is authorized. Alternatively, this QCI could be used for the default bearer of a UE/PDN for “premium subscribers.”
NOTE 6:
This QCI is typically used for the default bearer of a UE/PDN for non-privileged subscribers. Note that AMBR can be used as a “tool” to provide subscriber differentiation between subscriber groups connected to the same PDN with the same QCI on the default bearer.

In embodiment (2) an application table can be used as shown in Table 2. An application filter like functionality is created to filter packets based on the application mapping table entries which can be pre-assigned to either MeNB or SeNB. In one embodiment, the mapping table entries are based on IP information (such as an IP address). The packet filters can determine whether to route packets to a MeNB or SeNB based on the IP address information.

In one embodiment, an application mapping table can provide functionality to filter data flow within the bearer (such as shown in FIG. 5 in filter 506). An application mapping table can map an application entry to an IP address. For example, the application table contains different applications so that an IP to application mapping can be created at the setup. Table 2 is an example of the application table, but the number of applications and kind of applications should not be limited to what is shown.

TABLE 2
Example Application Mapping Table

| | |
|---|---|
| 0 | Voice IMS |
| 1 | Video IMS |
| 2 | SMS |
| 3 | Internet gaming |
| 4 | Disaster message board |
| 5 | Email |
| 6 | Web browser |
| 7 | IP Address |
| . . . | . . . |

In another embodiment (3), current traffic flow templates (TFTs) can be extended to provide application dependent filtering. A TFT is used to define different types of application data paths using packet filters. For example, an extended TFT can filter port 80 for http traffic and send through a MeNB while other traffic is sent through a SeNB. Multiple configurations can be configured to a TFT. For example, a packet filter can be use the following contents:

| | |
|---|---|
| 0 0 0 1 0 0 0 0 | IPv4 remote address type |
| 0 0 0 1 0 0 0 1 | IPv4 local address type |
| 0 0 1 0 0 0 0 0 | IPv6 remote address type |
| 0 0 1 0 0 0 0 1 | IPv6 remote address/prefix length type |
| 0 0 1 0 0 0 1 1 | IPv6 local address/prefix length type |
| 0 0 1 1 0 0 0 0 | Protocol identifier/Next header type |
| 0 1 0 0 0 0 0 0 | Single local port type |
| 0 1 0 0 0 0 0 1 | Local port range type |
| 0 1 0 1 0 0 0 0 | Single remote port type |
| 0 1 0 1 0 0 0 1 | Remote port range type |
| 0 1 1 0 0 0 0 0 | Security parameter index type |
| 0 1 1 1 0 0 0 0 | Type of service/Traffic class type |
| 1 0 0 0 0 0 0 0 | Flow label type |
| 1 0 0 0 0 0 0 1 | Macro cell or Small cell transmission preferred |

All other values can be reserved

In another embodiment a traffic flow/packet filter can be associated to the preferred cell type. One way of implementing this association between the packet filter and the preferred cell type is to associate a QoS parameter field to each packet filter identifier. This can be accomplished by adding the QoS parameters field in the “packet filter list” e.g., [3GPP TS 24.008: Core network protocols; Stage 3], as shown in Table 3 below

TABLE 3
Packet filter list when the TFT operation is “create
new TFT”, or “add packet filters to existing
TFT” or “replace packet filters in existing TFT”

| | | | | | | | |
|---|---|---|---|---|---|---|---|
| 8 | 7 | 6 | 5 | 4 | 3 | 2 | 1 |

| | | | |
|---|---|---|---|
| 0 | 0 | Packet filter | Packet filter |

| | | |
|---|---|---|
| Spare | direction 1 | identifier 1 |

Packet filter evaluation precedence 1
Length of Packet filter contents 1
Packet filter contents 1
Preferred cell type 1

| | | | |
|---|---|---|---|
| 0 | 0 | Packet filter | Packet filter |

| | | |
|---|---|---|
| Spare | direction 2 | identifier 2 |

Packet filter evaluation precedence 2
Length of Packet filter contents 2
Packet filter contents 2
Preferred cell type 2
. . .

| | | | |
|---|---|---|---|
| 0 | 0 | Packet filter | Packet filter |

| | | |
|---|---|---|
| Spare | direction N | identifier N |

Packet filter evaluation precedence N
Length of Packet filter contents N
Packet filter contents N
Preferred cell type N

Optionally, this could be done by adding a list of s in the Traffic Flow Template [3GPP TS 24.008: Core network protocols; Stage 3] as shown in Table 4 below

TABLE 4
Traffic flow template information element

| | | | | | | | |
|---|---|---|---|---|---|---|---|
| 8 | 7 | 6 | 5 | 4 | 3 | 2 | 1 |

Traffic flow template IEI
Length of traffic flow template IE

| | | |
|---|---|---|
| TFT operation | E bit | Number of packet |
| code | | filters |

Packet filter list
Parameters list
Preferred cell type list

In another embodiment (4) multiple TFTs can be configured to a single bearer. For example, a set of packets may satisfy the criteria of two TFTs. However, a TFT that is more restrictive can be used to determine which packets are routed to a secondary link (such as a SeNB).

In a single connectivity environment, one evolved packet system (EPS) bearer maps to one TFT. With the extended TFTs in a dual connectivity environment, the network (such as a MeNB) can set two or more TFTs to map to a single bearer. Under a dual connectivity bearer split, each split bearer is associated with one of the TFTs.

For example, in FIG. 6, TFT1 602 is divided into TFT2 604 and TFT3 606 (which can be written as TFT1=TFT2+TFT3). As packets 612 and 614 flow through TFT1 602 arriving into the MeNB, a packet filter separates the flow into flows 608 and 610 based on application information (such as IP address or application table entry). Packets 612 having a first application characteristic are associated with TFT2 604 and routed through MeNB 616. Packets 614 having a second application characteristic are associated with TFT3 606 and routed through SeNB 618.

In another embodiment, when SeNB 618 is added by MeNB 616, a TFT is configured and applied to one or more bearers that MeNB 616 decides to offload to SeNB 618. This TFT is re-configured such that an application dependent packet is filtered and offloaded to SeNB 618. In FIG. 6, for example, when SeNB 618 is added, MeNB 616 will configure TFT3 606 along with the bearer. The packet filters associated in TFT3 606 have to be a subset of TFT1 602. To do that, MeNB 616 can add, delete or modify packet filters in TFT. Similarly, MeNB 616 can modify the existing TFT2 604.

In another example of embodiment (4), an eNB can configure multiple TFTs for a single bearer when a SeNB is added. The eNB can follow the following operations: (1) when a single bearer (denoted B1) is established, a TFT (denoted TFT1) is configured; (2) upon adding a SeNB, bearer B1 is split into two bearers (denoted B2 and B3) (B2 is a bearer that connects to MeNB and B3 is a bearer that connects to SeNB); (3) a new TFT (denoted TFT3) is configured to B3 and this new TFT is also automatically configured to B1; and (4) when the SeNB is released, TFT3 is removed from B1 as well.

An example embodiment of a split bearer system 800 can be seen in FIG. 8. An application server 810 creates three application specific data flows that include packets 814, 816 and 818. The application server 810 transmits the packets 814, 816 and 818 through S/P-GW 812 to macro cell 822. Macro cell 822 determines which packets are transmitted by the macro cell 822 to a UE and those packets are offloaded to small cell 824 for transmission to the UE.

Within application server 810, different application specific data flows are created. Application 1 (802) creates packets 816. Application 2 (804) creates packets 818. Application 3 (806) creates packets 814. S/P-GW 812 receives these traffic flows and associates the flows with EPS bearers. Packets 814 form part of a first EPS bearer and a first traffic flow aggregate. Packets 816 and 818 form part of a second bearer and a corresponding second traffic flow aggregate.

One or more packet filters 820 receive these traffic flow aggregates at the macro cell 822 and route packets to a PDCP layer 826 or 834 (such as based on EPS bearer). Packets 814 are routed to PDCP layer 826 and are assigned a radio bearer. These packets 814 are then assigned a logical channel (dedicated traffic channel) in the RLC layer 828. The packets 814 then continue being processed through the MAC layer 830 (assigned a traffic channel —uplink shared channel (ULSCH)) and PHY layer 832 (assigned a physical channel—physical uplink shared channel (PUSCH)) for transmission to the UE.

Packets 816 are routed to PDCP layer 834 and are assigned a radio bearer. A packet filter within the PDCP layer 834 determines that packets 816 are to be transmitted by the macro cell 822 to the UE. These packets 816 are then assigned a logical channel (dedicated traffic channel) in the RLC layer 835. The packets 816 then continue being processed through the MAC layer 830 (assigned a traffic channel—ULSCH) and PHY layer 832 (assigned a physical channel—PUSCH) for transmission to the UE.

Packets 818 are routed to PDCP layer 834. A packet filter within the PDCP layer 834 determines that packets 816 are to be transmitted by the small cell 824 to the UE, resulting in a bearer split. The packets 818 are transmitted to small cell 824 to RLC layer 835 and are assigned a radio bearer. These packets 818 are then assigned a logical channel (dedicated traffic channel) in the RLC layer 835. The packets 816 then continue being processed through the MAC layer 838 (assigned a traffic channel—ULSCH) and PHY layer 840 (assigned a physical channel—PUSCH) for transmission to the UE.

In one example, a system 800 can be used to transfer data (such as video information) over a high speed link (that may not be as reliable as the macro cell 822 link) through the small cell 824, that may have a small coverage area. However, data corresponding to applications that need higher reliability (such as obtained through a larger coverage area but slower link speed) can be transferred over the macro cell 822 link.

An example embodiment of application dependent filtering system 900 can be seen in FIG. 9. Application specific packets 922, 924 and 926 are generated from applications 902, 904 and 906 on UE 908. A packet filter 936 routes packets 922, 924 to a first wireless interface for transmission to SeNB 911 based on application specific attributes. The packet filter 936 routes packets 926 to a second wireless interface for transmission to MeNB 910. MeNB 910 and SeNB 911 transmit the packets 922, 924 and 926 to S/P-GW 912. S/P-GW 912 transmits traffic flows 962, 964 and 966 to service 914 that includes application 1 (916), application 2 (918) and application 3 (920).

As the packet filter 936 resides above PDCP layers 928 and 938, traffic flow aggregates can be formed by TFTs (a first TFT that includes packets 922 and 924 and a second TFT that includes packets 926). Packets 922 and 924 flow through PDCP layer 928 (becoming associated with a radio bearer) through RLC layer 930 (becoming associated with a logical channel (DTCH)) through MAC layer 932 (becoming associated with a transport channel (ULSCH)) and through the PHY layer 934 (becoming associated with a physical channel (PUSCH)) to be transmitted to MeNB 910. Packets 926 flow through a second protocol stack through PDCP layer 938 (becoming associated with a radio bearer) through RLC layer 940 (becoming associated with a logical channel (DTCH)) through MAC layer 942 (becoming associated with a transport channel (ULSCH)) and through the PHY layer 944 (becoming associated with a physical channel (PUSCH)) to be transmitted to SeNB 911.

The packets 922, 924 and 926 are received by MeNB 910 and SeNB 911 and sent to S/P-GW 912, which can provide the packets to service 914 that includes application 1 (916), application 2 (918) and application 3 (920). A transmission from UE 908 to SeNB 911 based on packets 926 is routed through PHY layer 946 to MAC layer 948 to RLC layer 950 to PDCP layer 952 and then through an EPS bearer to S/P-GW 912 which routes packets 926 to application 920 (becoming traffic flow 962). A transmission from UE 908 to MeNB 910 based on packets 922 and 924 is routed through PHY layer 954 to MAC layer 956 to RLC layer 958 to PDCP layer 960 and then through an EPS bearer to S/P-GW 912 which routes packets 922 and 924 to applications 916 and 918 (becoming traffic flows 966 and 964).

For example, UE is running a GPS voice directions application. Current positioning information is reported by application 1 (902 on UE 908 and 916 on service 914). Voice directions are handled by application 2 (904 on UE 908 and 918 on service 914). A background map cache is provided by application 3 (906 on UE 908 and 920 on service 914). Positioning information (packets 924) and voice directions (packets 924) can be timing and reliability sensitive (as routes may need to be recalculated). However, a background map cache (packets 926) can be quickly loaded and stored for later use, allowing for high current data rates, but more unreliable connections if small updates are needed. MeNB 946 can determine that application 3 (906 on UE 908 and 920 on service 914) can make use of SeNB 911 and enables SeNB 911 for use (such as a request to turn on and/or accept connections from UE 908). MeNB 910 can then configure packet filters 936 or enable existing packet filters 936 (on both UE 908 and EPC, such as MeNB 910) to filter packets based on application based criteria (such as IP address, application of origin, etc.). Positioning information (packets 924) and voice directions (packets 922) are routed over a more robust (but potentially slower) link to MeNB 910 by packet filter 936. Background map cache (packets 926) are routed over a less robust (but potentially faster) link to SeNB 911 by packet filter 936.

In one embodiment (5), the packet filter also can be applied when the UE connects or dual connects to WLAN (e.g., Wi-Fi) networks. The eNB will configure the TFT and associated packet filters on the LTE bearer and WLAN link. For example, FIG. 7 shows an example of dual connectivity of a UE 702 with an eNB 704 in using licensed spectrum (LTE 708) and a WLAN AP 706 using unlicensed spectrum (WLAN 710). Data from bearer S1 716 that is received from S-GW 714 can be split between eNB 704 and AP 706 based on application information (such as through a TFT, application table, QCI table, etc.). Internet access 718 can also be provided through a non-seamless WLAN offload (NSWO) link 720. In some embodiments the eNB 704 and AP 706 form a transmission unit 712. The eNB 704 and AP 706 share a link. The eNB 704 can offload traffic to the AP 706 using a packet filter based on application specific information (such as seen in FIG. 4).

In some embodiments, the WLAN technology can be used instead of an SeNB (as seen in FIGS. 8 and 9). For example, extended TFTs (as discussed in embodiment 4) or multiple TFTs (as discussed in embodiment 5).

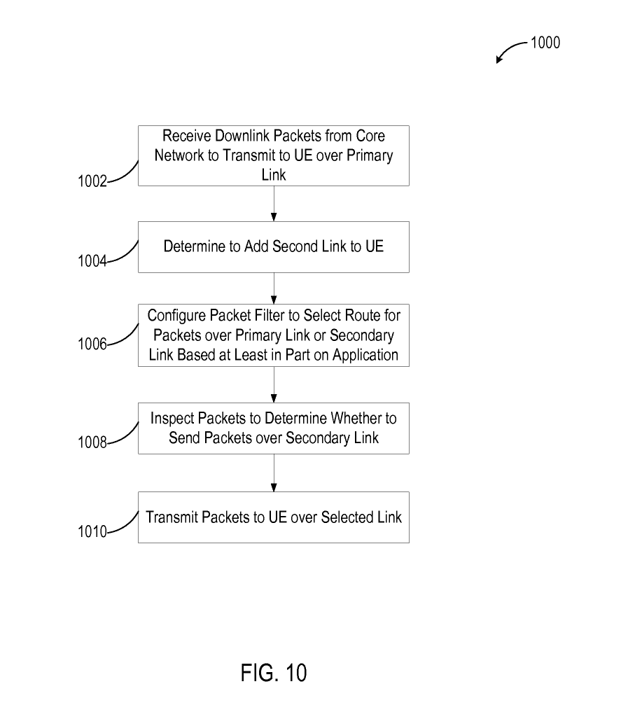

FIG. 10 shows a method 1000 for application specific routing in dual connectivity. The method can be accomplished by systems such as those shown in FIG. 1, including anchor tower 104, small cell transceiver 106, UE 102, network infrastructure 118 (such as MME, etc.). In box 1002, a MeNB can receive downlink packets from the core network to transmit to a UE over a primary link (such as over licensed spectrum using LTE). In box 1004, MeNB (or in some cases MME or other part of EPC) determines to add a second link to the UE (which can be due to application specific demands). In box 1006, a packet filter is configured on UE and MeNB to select a route over the primary link or secondary link based on application information (such as IP address, application table, etc.). In some embodiments the packet filters are used in conjunction with TFTs. In box 1008, downlink packets are inspected by packet filters to determine whether to send the packets over the secondary link (such as a SeNB link, WLAN link, mmWave link, etc.) or primary link. In box 1010, packets are routed to the selected link and transmitted to the UE.

In another embodiment, a UE can receive a message from a MeNB to connect to a SeNB. The UE can connect to the SeNB and enable a packet filter (which can be selected from pre-configured packet filters, received from the MeNB or other part of an EPC, or dynamically configured based on application information or demand information). Packets from the UE can be received by the packet filter and directed to a primary wireless interface (connected to the MeNB) or a secondary wireless interface (connected with the SeNB) based on application information. In some embodiments, this can result in a split radio bearer.

It should be recognized that a primary link and secondary link can be selected from various technologies and implementations. For example, a primary link can include protocols (LTE, LTE-U (LTE over unlicensed spectrum, which is sometimes referred to as licensed assisted access (LAA)), WLAN (also referred to as Wi-Fi™), mmWave, etc.), spectrum (licensed spectrum, unlicensed spectrum, shared spectrum, etc.) and other technologies. A secondary link can include the same protocols, spectrum and technologies. For example, in some embodiments, a primary link can be WLAN over unlicensed spectrum and a secondary link can be mmWave technology over licensed spectrum. Descriptions applied to a MeNB and SeNB can be applied to other wireless transceivers (such as a WLAN AP, mmWave transceiver, etc.).

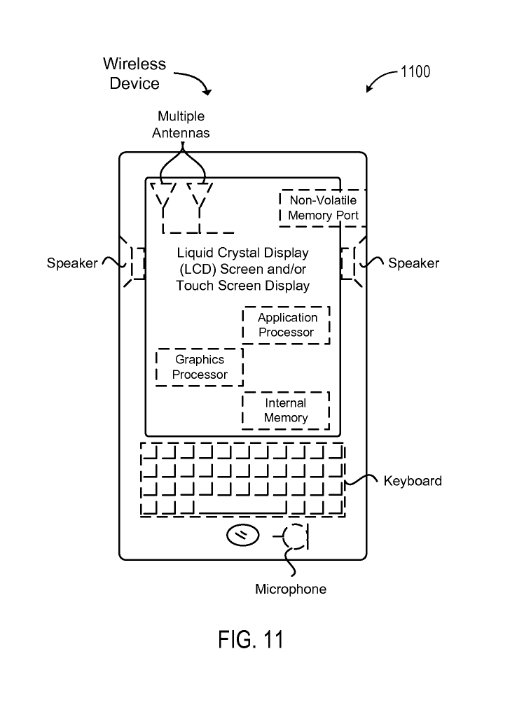

FIG. 11 is an example illustration of a mobile device, such as a UE, a mobile station (MS), a mobile wireless device, a mobile communication device, a tablet, a handset, or another type of mobile wireless device. The mobile device can include one or more antennas configured to communicate with a transmission station, such as a base station (BS), an eNB, a base band unit (BBU), a remote radio head (RRH), a remote radio equipment (RRE), a relay station (RS), a radio equipment (RE), or another type of wireless wide area network (WWAN) access point. The mobile device can be configured to communicate using at least one wireless communication standard including 3GPP LTE, WiMAX, HSPA, Bluetooth, and Wi-Fi. The mobile device can communicate using separate antennas for each wireless communication standard or shared antennas for multiple wireless communication standards. The mobile device can communicate in a WLAN, a wireless personal area network (WPAN), and/or a WWAN.

FIG. 11 also provides an illustration of a microphone and one or more speakers that can be used for audio input and output from the mobile device. The display screen can be a liquid crystal display (LCD) screen or other type of display screen, such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the mobile device. A keyboard can be integrated with the mobile device or wirelessly connected to the mobile device to provide additional user input. A virtual keyboard can also be provided using the touch screen.

Computing systems as discussed herein (such as UEs, eNBs, WLAN APs, systems that include processors, etc.) can be viewed as an information passing bus that connects various components. A computing system includes a processor having logic for processing instructions. Instructions can be stored in and/or retrieved from memory and a storage device that includes a computer-readable storage medium. Instructions and/or data can arrive from a network interface that can include wired or wireless capabilities. Instructions and/or data can also come from an I/O interface that can include such things as expansion cards, secondary buses (e.g., USB, etc.), devices, etc. A user can interact with the computing system through user interface devices and a rendering system that allows the computer to receive and provide feedback to the user.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the above description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

### Examples

The following examples pertain to further embodiments.

Example 1 is a A user equipment (UE) for having dual connectivity that includes a processor, transceiver system and packet filter. The processor is configured to execute one or more applications that generate network traffic comprising packets for transmission from the UE. The transceiver system is configured to communicate the packets over at least two wireless channels. The packet filter is configured to inspect a packet from the network traffic generated from the one or more applications and select a route for transmission of the packet over one of the at least two wireless channels based at least in part on its association with an application from the one or more applications.

In Example 2, the UE of Example 1 can optionally have a first channel of the at least two wireless channels comprise a licensed set of frequencies.

In Example 3, UE of Example 2 can optionally have a second channel of the at least two channels comprise a wireless local area network (WLAN).

In Example 4, the UE in Examples 1-3 can optionally include a packet filter configuration that is selected from a set of preconfigured packet filter configurations.

In Example 5, the UE Examples 1-4 can optionally have the packet filter route packets from the packet data convergence protocol (PDCP) layer.

Example 6, is a system for dual connectivity including a gateway, a primary enhanced node B (eNB) and a secondary eNB. The gateway is configured to communicate packets associated with an evolved packet system (EPS) bearer with a destination of user equipment (UE). The primary enhanced node B (eNB) includes a packet splitter configured to split the EPS bearer into at least two streams of packets. A first stream is communicated over a first set of wireless frequencies from the primary eNB to the UE. A second stream is routed through a secondary eNB. The secondary eNB is configured to communicate the second stream over a second set of wireless frequencies to the UE.

In Example 7, the system of Example 6 can optionally configure a packet splitter to use a quality of service class identifier (QCI) table to determine the first stream and the second stream.

In Example 8, the system of Example 6 can optionally configure the packet splitter to use an application mapping table to determine the first stream and the second stream.

In Example 9, the system of Example 6 can optionally configure the primary eNB to map at least two traffic flow templates (TFTs) to a single bearer. The packet splitter can also be further configured to assign the packets to the first stream or the second stream based at least in part on the at least two TFTs.

In Example 10, the system of Examples 6-9 can optionally be configured to have the secondary eNB communicate over unlicensed frequencies.

In Example 11, the system of Examples 6-10 can optionally configure the primary eNB to map a second more restrictive traffic flow template (TFT) to a single bearer that has a first TFT. The packet splitter can also be further configured to route at least a portion of the packets to the second stream based at least in part on the packets matching the second TFT.

Example 12 is a method of application specific routing. The method includes connecting a third generation partnership project (3GPP) compatible primary wireless link to user equipment (UE). The method also includes receiving a downlink packet from a core network. The method includes determining to add a secondary wireless link to user equipment (UE). The method also includes enabling a packet splitter to determine allocation of packets between the primary wireless link and the secondary wireless link. The method includes inspecting the downlink packet to determine an association with an application. The method also includes determining whether to send the downlink packet to the UE over the primary wireless link or the secondary wireless link based at least in part on the association.

In Example 13, the method of Example 12 can optionally include splitting a radio bearer between the primary wireless link and the secondary wireless link based at least in part on the association of packets within the radio bearer with an application.

In Example 14, the method of Examples 12-13 can optionally establishing a first bearer and an associated first traffic flow template (TFT) configured to transmit over the primary wireless link. The method can include splitting the first bearer into a second bearer and a third bearer. The method can also include associating the second bearer with the primary wireless link. The method can include associating the third bearer with the secondary wireless link. The method can also include configuring a third TFT to associate with the third bearer and the first bearer.

In Example 15, the method of Example 12-14 can optionally include mapping two or more traffic flow templates (TFT) to a single bearer.

In Example 16, the method of Examples 12-15 can optionally include inspecting the downlink packet to determine the association with an application further comprises determining a quality of service class indicator (QCI) value assigned to an application.

Example 17 is user equipment (UE) for communicating in a dual connectivity environment that includes a first wireless interface, a second wireless interface and a processor. The first wireless interface is configured to communicate over a licensed set of frequencies using a radio bearer. The second wireless interface is configured to communicate over a second set of frequencies. The processor is configured to receive a set of uplink packets belonging to a bearer. The processor is additionally configured to determine allocation of the set of uplink packets between the first wireless interface and the second wireless interface based at least in part on the uplink packets association with an application The processor is also configured to cause a first subset of the uplink packets to be sent over the first wireless interface based at least in part on the determined allocation. The processor can also be configured to cause a second subset of the uplink packets to be sent over the second wireless interface based at least in part on the determined allocation.

In Example 18, the UE of Example 17 can optionally perform allocation of the packets to the first wireless interface based on a determination that the first wireless interface has a higher reliability than the second wireless interface.

In Example 19, the UE of Examples 17-18 can optionally perform allocation of the packets to the second wireless interface based on a determination that the second wireless interface has a higher throughput than the first wireless interface.

In Example 20, the UE of Examples 17-19 can optionally include configuring the processor for receiving a configuration over the first wireless interface for determining the allocation of the uplink packets, the configuration associating an application with the first wireless interface or the second wireless interface.

What is claimed is:

1. A user equipment (UE) for having dual connectivity comprising:
a processor configured to execute one or more applications that generate network traffic comprising packets for transmission from the UE;
a transceiver system configured to communicate the packets over at least two wireless channels, the at least two wireless channels including a primary link and a secondary link;
a packet filter configured to inspect a packet from the network traffic generated from the one or more applications and select a route for transmission of the packet over one of the at least two wireless channels based at least in part on its association with an application from the one or more applications.

2. The UE of claim 1, wherein a first channel of the at least two wireless channels comprises a licensed set of frequencies.

3. The UE of claim 2, wherein a second channel of the at least two wireless channels comprises a wireless local area network (WLAN).

4. The UE of claim 1, wherein a packet filter configuration is selected from a set of preconfigured packet filter configurations.

5. The UE of claim 1, wherein the packet filter routes packets from the packet data convergence protocol (PDCP) layer.

6. A system for dual connectivity comprising:
a gateway configured to communicate packets associated with an evolved packet system (EPS) bearer with a destination of user equipment (UE);
a primary enhanced node B (eNB) comprising:
a packet splitter configured to split the EPS bearer into at least two streams of packets, a first stream being communicated over a first set of wireless frequencies from the primary eNB to the UE, a second stream being routed through a secondary eNB; and
the secondary eNB configured to communicate the second stream over a second set of wireless frequencies to the UE.

7. The system of claim 6, wherein the packet splitter is further configured to use a quality of service class identifier (QCI) table to determine the first stream and the second stream.

8. The system of claim 6, wherein the packet splitter is further configured to use an application mapping table to determine the first stream and the second stream.

9. The system of claim 6, wherein the primary eNB is configured to map at least two traffic flow templates (TFTs) to a single bearer; and
wherein the packet splitter is further configured to assign the packets to the first stream or the second stream based at least in part on the at least two TFTs.

10. The system of claim 6, wherein the secondary eNB is configured to communicate over unlicensed frequencies.

11. The system of claim 6, wherein the primary eNB is configured to map a more restrictive second traffic flow template (TFT) to a single bearer that has a first TFT; and
wherein the packet splitter is further configured to route at least a portion of the packets to the second stream based at least in part on the packets matching the second TFT.

12. A method of application specific routing comprising:
connecting a third generation partnership project (3GPP) compatible primary wireless link to user equipment (UE);
receiving a downlink packet from a core network;
determining to add a secondary wireless link to the UE;
enabling a packet splitter to determine allocation of packets between the primary wireless link and the secondary wireless link;
inspecting the downlink packet to determine an association with an application; and
determining whether to send the downlink packet to the UE over the primary wireless link or the secondary wireless link based at least in part on the association.

13. The method of claim 12, further comprising splitting a radio bearer between the primary wireless link and the secondary wireless link based at least in part on the association of packets within the radio bearer with the application.

14. The method of claim 12, further comprising:
establishing a first bearer and an associated first traffic flow template (TFT) configured to transmit over the primary wireless link;
splitting the first bearer into a second bearer and a third bearer;
associating the second bearer with the primary wireless link;
associating the third bearer with the secondary wireless link; and
configuring a third TFT to associate with the third bearer and the first bearer.

15. The method of claim 12, further comprising mapping two or more traffic flow templates (TFT) to a single bearer.

16. The method of claim 12, wherein inspecting the downlink packet to determine the association with the application further comprises determining a quality of service class indicator (QCI) value assigned to the application.

17. User equipment (UE) for communicating in a dual connectivity environment comprising:
a first wireless interface configured to communicate over a licensed set of frequencies using a radio bearer;
a second wireless interface configured to communicate over a second set of frequencies; and
a processor configured to:
receive a set of uplink packets belonging to a bearer;
determine allocation of the set of uplink packets between the first wireless interface and the second wireless interface based at least in part on an association of the uplink packets with an application;
cause a first subset of the set of the uplink packets to be sent over the first wireless interface based at least in part on the determined allocation; and
cause a second subset of the set of the uplink packets to be sent over the second wireless interface based at least in part on the determined allocation.

18. The UE of claim 17, wherein the allocation of the first subset of the set of uplink packets to the first wireless interface is based on a determination that the first wireless interface has a higher reliability than the second wireless interface.

19. The UE of claim 17, wherein the allocation of the second subset of the set of uplink packets to the second wireless interface is based on a determination that the second wireless interface has a higher throughput than the first wireless interface.

20. The UE of claim 17, wherein the processor is further configured to receive a configuration over the first wireless interface for determining the allocation of the set of uplink packets, the configuration associating the application with the first wireless interface or the second wireless interface.
